(19) United States
(12) Patent Application Publication
(10) Pub. No.: US 2026/0367671 A1
(43) Pub. Date: Nov. 19, 2026

(54) MODULAR ACCESSORY SYSTEM FOR PERSONAL COMPUTING DEVICES INCLUDING BACKGROUND DATA TRANSFER

(71) Applicant: Raven Resonance Inc., San Francisco, CA (US)

(72) Inventors: Ivan France, Saratoga, CA (US); Curtis Aumiller, San Jose, CA (US); Thomas Suarez, San Francisco, CA (US)

(73) Assignee: Raven Resonance Inc., San Francisco, CA (US)

(21) Appl. No.: 19/676,704

(22) Filed: May 13, 2026

Related U.S. Application Data
(60) Provisional application No. 63/806,475, filed on May 15, 2025.

(51) Int. Cl. G06F 1/16

(52) U.S. Cl. CPC G06F 1/1635; G06F 1/163; G06F 1/1686

(57) ABSTRACT

A modular accessory system for personal computing devices having an accessory interface with at least one power and one data connection terminal, with one or more modular accessories configured to be selectively and removably attached to the personal computing device through the accessory interface. The modular accessories include data storage memory for receiving digital data from the computing device and transfer the digital data to an accessory cradle when the modular accessory is inserted. Larger capacity battery cells and memory chips on the accessor cradle are configured to separately and securely transfer the digital data to the cradle without depleting the modular battery cell of the modular accessory during large or multiple data transfers.

### RELATED APPLICATION

This patent application relates to and claims priority from U.S. Provisional Patent Application No. 63/806,475 entitled “Modular Accessory System for Personal Computing Devices Including Background Data Transfer” filed 5/15/2025 and is incorporated herein by reference including its specification.

### FIELD OF THE INVENTION

The present invention is directed to a modular accessory system for personal computing and similar devices. The inventive modular accessory system preferably includes one or more detachable accessory modules with connections allowing for both power transfer and data transfer. The accessory modules are most preferably physically connected to the computing devices either by magnets or some other mechanical locking mechanism. Through such physical connection, the accessory modules are connected to the internal circuitry of the computing devices via induction or exposed pins – such as pogo or spring-loaded pins. With the data connections, the modular batteries preferably include on-board memory storage or are capable of receiving data external data storage like memory cards.

### BACKGROUND OF THE INVENTION

Personal computing devices come in many forms and functions. For example, personal computing devices may be wearable electronic devices, such as smart glasses, smart watches, and other devices that attach to or are worn by a user. In addition, personal computing devices may come in other non-wearable forms, such as GPS devices, cameras, microphones, activity trackers, health monitors, etc. Regardless of the specific form, such personal computing devices have become much more common in recent years. With the increase in numbers and users, the need for powering such devices and the use of various accessories with such devices is paramount, particularly continuously powering such devices without interruption. In addition, with the increased use of accessories with such electronic devices, the monitoring and maintenance of such modular accessories is vital.

The need for reliably and consistently powering such personal computing devices, is of critical important, particularly when transferring data files content from the device to a more permanent memory platform. With personal computing devices, the lack of a permanent or wired connection to a deep power reserve, particularly with smaller batteries as are found on personal computing devices, increases concern for power management and minimizing large power drains. The transfer of data files from a personal computing device to a more permanent platform is a typical situation that can rapidly drain the power reservoir on a small battery.

Accordingly, there is a need for an improved battery and data storage/transfer system for wearable electronic devices that allows for continuous, uninterrupted use during recharge, and also allows for reliable data transfer with sufficient power supply and uninterrupted usage. The present invention fulfills these needs and provides other related advantages.

### SUMMARY OF THE INVENTION

The present invention has been developed in response to the present state of the art, and in particular, in response to the problems and needs in the continuous, uninterrupted use and operation of personal computing devices, particularly when transferring data files from such devices to another device. Such invention relates to a system and configuration of modular accessories, in particular batteries, that allow for replacement or “hot-swapping” of one or more accessory modules while the personal computing device is in continuous use or operation, and also allows for the seamless transfer of data files without causing too much drain on the battery power or creating performance issues in the personal computing device. In particular, for smart glasses or similar personal computing devices, a system of modular batteries with on-board data storage and power management with data transfer and storage capabilities that allows for replacing a depleted (or nearly depleted) battery module with a fully charged battery module without interruption of operation or even use of the personal computing devices, i.e., while wearing the smart glasses.

Each battery module can be located anywhere on the personal computing device where compatible connection points are installed. In the case of smart glasses, two modular batteries may be attached to the stems or temple arms of the glasses frame, i.e., behind the ear, one on each stem. Such attachment may be either mechanically or magnetically. Each battery module can be added or removed by a user at-will and in a “hot-swappable” fashion, meaning the personal computing device can keep itself powered on even when the battery module is disconnected. This “hot-swappable” feature may be achieved by only disconnecting one battery at a time or by incorporating a capacitor or other short-term storage device internal to the personal computing device.

The rechargeable modular batteries can be removed and charged external to the personal computing device, allowing modular batteries to be quickly swapped out without requiring the user to switch to a different device. For example, when the device is smart glasses, this may mean uninterrupted work or other usage, as well as continued utilization of prescription lenses, hearing assistance, or similar features. When removed or swapped, the modular batteries may be recharged in a pocket-sized carrying charging case, as opposed to a case for containing the entire glasses frame. Alternatively, the modular batteries may be charged on a base station or similar platform.

A modular battery system of the type described may also include memory components on the modular batteries and in the charging case, base station, or similar platform to facilitate storage and transfer of digital data. Wireless media data transfer involving Bluetooth, Wi-Fi direct or similar protocols typically use a lot of power and can rapidly drain energy storage in modular batteries, particularly for modular batteries of the size that are typically used in personal computing devices. Such energy drain is amplified when such transfer occurs in the background, as other CPU processing and functions of the personal computing device typically continue during background transfer. For consistent and reliable use, media data transfer is preferably seamless, particularly if the purpose of the device is to record media, i.e. photos and video. A user might swap modular batteries several times throughout the day. With wireless preview and media transfer becoming more common on such devices, power consumption and latency remain important concerns. Most systems rely on SD cards and wired transfers to minimize such issues.

With modular batteries, data storage may be integrated into the battery module itself. Such data storage in the modular batteries may take the form of permanent soldered memory components or removable formats like micro-SD cards. When a modular battery is removed from the personal computing device and placed in a charging case, base station, or similar platform, data files stored on memory in the modular battery may be moved to comparable data storage in the charging case, base station, or similar platform. The media data files that were transferred to the data storage of the charging case, base station, or similar platform can then be wirelessly transferred to the phone or cloud. This operational configuration then places the power burden of the wireless data transfer on the typically much larger energy reservoir of the case, base station, or similar platform rather than on the modular batteries themselves. Such case, base station, or similar platform tend to have larger rechargeable batteries or are wired to a larger power reservoir, i.e., an electrical outlet. A battery case, base station, or similar platform can accommodate and sync multiple modular batteries. With a battery case, base station, or similar platform, the multiple modular batteries may be simultaneously synced to a computer or phone, all while the docking station is connected to a deeper power reservoir.

The combination of data storage and modular batteries provide users with the advantages of swappable storage and batteries without needing to separately track each component. Such combination may also work with a variety of wireless or personal computing devices, such as security cameras, audio recorders, or other logging sensors that rely on wireless and/or background transfer of large quantities of data where wireless transfer may take too much time or drain too much power from a modular battery. Examples might include, content creators with cameras, or researchers with animal tags, where there is only a brief moment to interact with the sensor to both transfer data and recharge the system. Swapable modular batteries with internal data storage can accomplish both seamlessly. For security, data storage on modular batteries can be partitioned and encrypted to allow for several different users or personal computing devices to use the same modular batteries. Such security allows modular batteries to be used across multiple personal computing devices without risk of unintentionally sharing data – or if a modular battery is lost any stored data would remain be secure.

The present invention is directed to a modular accessory system for personal computing devices. The system includes a personal computing device having internal circuitry and at least one connection point configured to provide both power transfer and data transfer. A modular accessory is removably attachable to the personal computing device at the at least one connection point, with the modular accessory including a modular power component configured to supply power to the personal computing device and a modular memory component configured to store and transfer data. An accessory storage case is configured to receive the modular accessory when removed from the personal computing device, with the accessory storage case including a case power component having a greater capacity than the modular power component and a case memory component having a greater capacity than the modular memory component. The accessory storage case is configured to transfer data from the modular memory component to the case memory component or a separate mobile computing device when under power from the case power component.

The accessory storage case preferably transfers data from the modular accessory to the separate mobile computing device by a wired connection or by a wireless connection comprising at least one of a local area network, Wi-Fi, and Bluetooth. The data is transferred from the modular accessory to the accessory storage case by a direct physical connection between the modular accessory and the accessory storage case. The direct physical connection between the modular accessory and the accessory storage case is preferably achieved by induction or exposed pins. The data transfer from the modular accessory to the accessory storage case is preferably initiated automatically upon placement of the modular accessory in the accessory storage case, or upon manual activation by a user.

The at least one connection point connects the modular accessory to the internal circuitry of the personal computing device via induction or exposed pins, the connection point providing at least one power contact, at least one ground contact, and at least one data contact. The modular accessory is preferably physically attached to the personal computing device by a magnet or a mechanical locking mechanism.

The personal computing device is preferably a wearable electronic device selected from the group consisting of smart glasses, a smart watch, a GPS device, a camera, a microphone, an activity tracker, and a health monitor, and wherein the modular accessory is a rechargeable modular battery. In a particular embodiment, the personal computing device is a pair of smart glasses, wherein the rechargeable modular battery is attached to a temple arm of the smart glasses.

In an alternate embodiment, the present invention is directed to a modular battery system for personal computing devices, including a personal computing device having internal circuitry and at least one connection point configured to provide both power transfer and data transfer. A rechargeable modular battery is removably attachable to the personal computing device at the at least one connection point, with each modular battery including a modular battery cell configured to supply power to the personal computing device and a modular data storage configured to store digital data from the personal computing device. An accessory storage case is configured to receive the modular battery, the accessory storage case comprising a case power component having a greater capacity than the modular battery cell and a case data storage having a greater capacity than the modular data storage. The accessory storage case is configured to transfer data from the modular data storage to the case data storage and a mobile computing device while under power from the case power component rather than from the modular battery cell so as not to drain the modular battery cell during large data transfer.

The accessory storage case is configured to transfer data to the mobile computing device by a wired connection or by a wireless connection comprising at least one of a local area network, Wi-Fi, and Bluetooth. The data may be transferred from the modular battery to the accessory storage case by a direct physical connection between the modular battery and the accessory storage case comprising induction or exposed pins. The accessory storage case may also be configured to simultaneously receive a plurality of modular batteries and to consolidate data from the respective modular data storage elements of the plurality of modular batteries for transfer to the separate mobile computing device.

The modular data storage of the modular battery is preferably partitioned and encrypted to permit use of the modular battery across multiple personal computing devices without unintentional sharing of data, and to secure stored data if the modular battery is lost. The at least one connection point connects the modular battery to the internal circuitry of the personal computing device via induction or exposed pins, the connection point providing at least one power contact, at least one ground contact, and at least one data contact.

In a still further embodiment, the present invention is directed to a modular battery system for smart glasses, including a smart glasses frame having internal circuitry and at least one connection point on at least one temple arm configured to provide both power transfer and data transfer. The system also includes at least one modular battery removably attachable at the at least one temple arm at the at least one connection point, each modular battery having a modular battery cell configured to supply power to the smart glasses frame and a modular data storage chip configured to store digital data from the smart glasses frame. The system further includes an accessory storage case configured to receive the at least one modular battery, the accessory storage case comprising a case power storage having a greater capacity than the modular battery cell and a case data storage having a greater capacity than the modular data storage chip. The accessory storage case is configured to transfer data from the modular data storage chip to at least one of the case data storage and a separate mobile computing device when under power from the case power storage rather than from the modular battery cell.

The accessory storage case may transfer data to the separate mobile computing device by a wired connection or by a wireless connection comprising at least one of a local area network, Wi-Fi, and Bluetooth. The data is preferably transferred between the smart glasses frame and the at least one modular battery through a staged process including: as a first stage, where digital data is stored in internal memory of the smart glasses frame; as a second stage, where the digital data is transferred from the smart glasses frame to the modular data storage chip through the at least one connection point; as a third stage where the digital data is transferred from the modular data storage chip to the case data storage upon placement of the at least one modular battery in the accessory storage case; and as a fourth stage, where the accessory storage case transfers the digital data to the separate mobile computing device or to cloud storage using power from the case power storage.

The modular data storage chip is preferably partitioned and encrypted to permit the at least one modular battery to be used across multiple smart glasses frames without unintentional sharing of data from other users, and to secure stored digital data if the at least one modular battery is lost. A first modular battery may be attached to a first connection point of a first temple arm of the smart glasses frame and a second modular battery may be attached to a second connection point of a second temple arm of the smart glasses frame. The first and second connection points connect the first and second modular batteries to the internal circuitry of the smart glasses frame via induction or exposed pins including at least one power contact, at least one ground contact, and at least one data contact in each connection point.

Other features and advantages of the present invention will become apparent from the following more detailed description, taken in conjunction with the accompanying drawings, which illustrate, by way of example, the principles of the invention.

### BRIEF DESCRIPTION OF THE FIGURES

These and other features and advantages of the present invention will become appreciated, as the same becomes better understood with reference to the specification, claims and drawings herein:

FIG. 1 is a perspective, solid-form view of an embodiment of a personal computing device, e.g., smart glasses, embodying the present invention;

FIG. 2 is a top plan, view of the smart glasses of FIG. 1;

FIG. 3 is a close-up perspective view of an accessory module, e.g., proximate to a temple arm of the smart glasses according to the present invention;

FIG. 4 is a perspective view of the smart glasses of FIG. 1, showing a first accessory module attached to a temple arm and a second accessory spaced apart from another temple arm;

FIG. 5 is a system view of a modular case, modular cradle, and smart glasses;

FIG. 6 is a system view of a modular cradle having a wireless connection to remote computing device.

### DETAILED DESCRIPTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present there between. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section.

As used herein, the singular forms “a,” “an,” and “the,” are intended to include the plural forms as well, unless the context clearly indicates otherwise. It will be further understood that the terms “comprises” and/or “comprising,” “includes” and/or “including,” and “have” and/or “having,” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” and “upper” or “top,” and “inner” or “outer,” may be used herein to describe one element’s relationship to another elements as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes and configurations of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing.

The invention described herein is primarily concerned with the power supply and management used in personal computing devices such as wearable electronic devices or smart glasses and similar wearable technology, particularly as the same may relate to large data transfer, for example, large digital files such as recorded audio/video files. This disclosure is not necessarily concerned with the function and operation of the wearable devices beyond the power supply and management, and digital file data transfer associated therewith. Features such as display, audio/video, data communication, and control of such devices are intended to conform to the current state of the art of such features, or as such state of the art may develop in the future.

At a basic level, the inventive power supply system or apparatus is configured such that the manner in which the power stored in one or more modular batteries is selectively depleted so as to optimize battery life, such as by minimizing depleting/recharging cycles and/or fully depleting a single battery of charge. Through such configuration, the battery modules maintain sufficient charge for steady reliable operation of the computing device by maintaining a minimum charge in one or more modular batteries – this before fully depleting one modular battery and/or by transferring a portion of a higher charge from one modular battery to another modular battery with a lower charge.

The present invention is directed to a power supply and data transfer system or apparatus for personal computing or wearable electronic devices, such as smart glasses. With personal computing or wearable electronic device, such as smart glasses, a power supply and data transfer system or apparatus provides one or more modular accessories, e.g. batteries, that are selectively removable from the device in a manner where the device is continuously powered and/or usable, including during recharging, replacement, or swapping of one or more of the modular batteries.

In this system, each of the swappable modular batteries preferably includes general purpose data connections and on-board memory for data transfer and storage from the wearable electronic devices. In the inventive configuration, during wireless data transfer, rather than using the energy stored in the same battery cells that power the wearable electronic device, the system provides for wireless data transfer to occur when the modular accessory with the modular data component is placed in a storage case. The storage case is configured so as to contain a case battery component with much larger capacity than the modular battery cell. Wireless data transfers performed when connected to the case battery component avoids depleting the power stored in the modular battery cell under the load of wireless data transfer. As an alternative to a second modular battery, the computing device may also be compatible with other modular accessories, such as cameras, microphones, GPS, activity trackers, health monitors, etc.

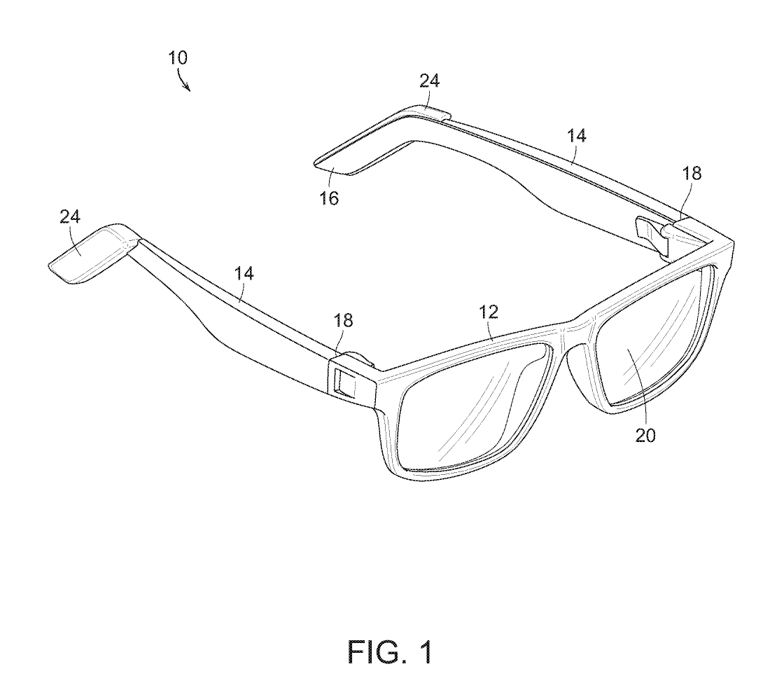

FIGS. 1-4 generally show the personal computing or wearable electronic device as smart glasses, including swappable modular accessories in the form of batteries. While the following description primarily focuses on smart glasses and related modular accessories, the modular system of the present invention has broader application for accessories that are used with a variety of personal computing devices.

In the embodiments described herein, the electronic devices are described as smart glasses, but may also comprise other forms of stand-alone personal or wearable computing devices, including but not limited to GPS devices, cameras, microphones, activity trackers, health monitors, and similar devices. Similarly, while the embodiments of modular accessories are primarily described as swappable batteries, they may also comprise other modules, including but not limited to GPS modules, camera modules, microphone modules, activity tracker modules, and health monitor modules.

Further, the present invention utilizes a modular accessory system, including power supply devices, for personal computing devices, including wearable devices such as smart glasses, wherein the power supply device or apparatus provides one or more battery modules that are selectively removable from the wearable device in a manner where the device is continuously powered and/or usable, including during recharging, replacement, or hot-swapping of one or more of the battery modules. In this system, each of the modular accessories – whether battery modules, GPS modules, camera modules, microphone modules, activity tracker modules, health monitoring modules, etc. – preferably includes one or more general purpose data connections as further described below. The terms “battery module” and “modular battery” (including plurals of the same) are used interchangeably throughout this written description and are intended to mean and refer to the same parts.

The modular accessories are preferably configured to be removed and/or replaced on the personal computing device without interrupting operation or requiring shut-down of the wearable device. In particular, with battery modules, the inventive power supply system is configured such that the power stored in one or more batteries is selectively depleted in a manner so as to optimize battery life, such as by minimizing depleting/recharging cycles and/or fully depleting a single battery of charge. Through such configuration, the battery modules maintain sufficient charge for steady reliable operation of the wearable device by maintaining a minimum charge in one or more battery modules – this before fully depleting one battery and/or by transferring a portion of a higher charge from one battery to another battery with a lower charge. Similarly, when the modular accessories include one battery module and one other accessory module (i.e., activity tracker), the wearable device can transfer charge from the one battery module to operate or maintain the other accessory module for steady reliable operation.

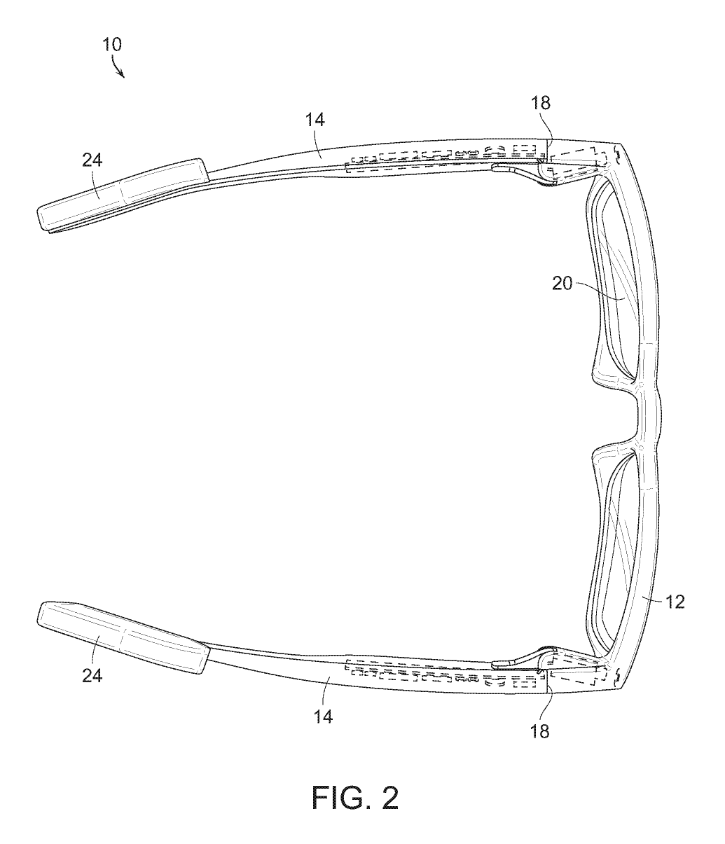

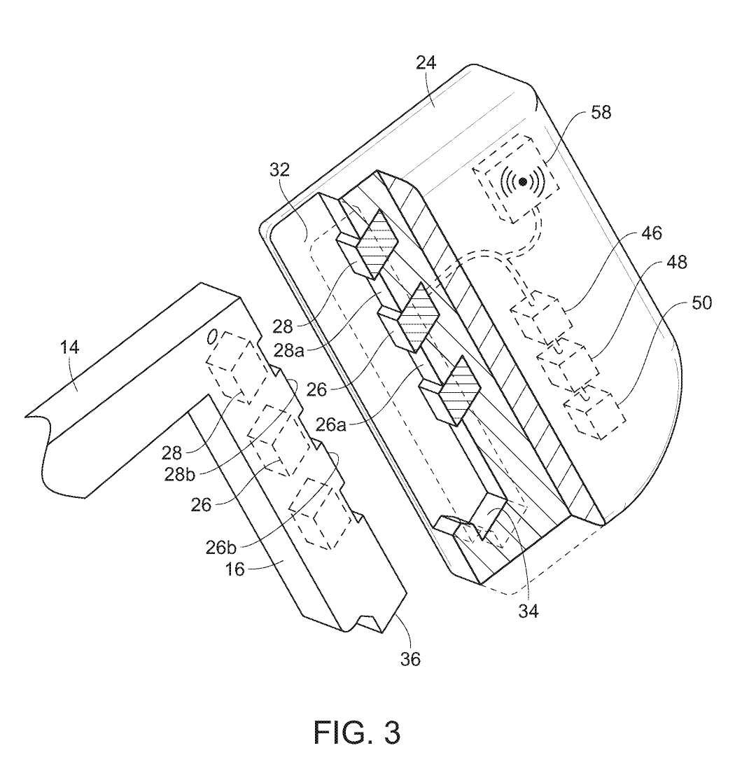

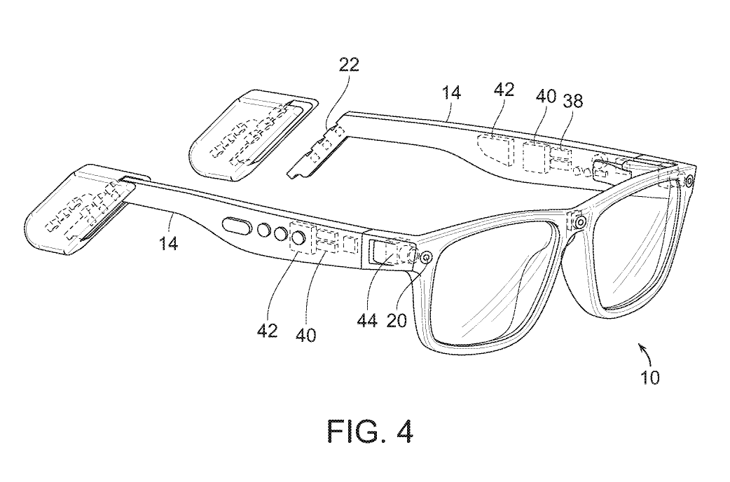

A particular embodiment of the personal or wearable computing device of the present invention is preferably in the form smart glasses 10, shown in FIGS. 1 and 2. Such smart glasses 10 have the typical features of a frame 12, temples or temple arms 14, temple tips 16, hinges 18, and lenses 20. In this embodiment, the temple tips 16 are preferably configured with battery receptacles 22 that receive battery modules 24. FIGS. 3 and 4 illustrate an embodiment where the battery modules 24 engage the temple tips 16, wherein the extreme ends of the temple tips 16 are configured to be inserted into a groove 32 on the battery module 24. The groove 32 has a depth configured to accept a sufficient portion of the temple tip 16 to provide stability to the connection. FIG. 3 shows in close-up the battery module 24 in spaced relation to the temple tip 16. FIG. 4 shows alternately one battery module 24 connected to the temple tip 16 and another battery module 24 in spaced relation to the other temple tip 16.

Corresponding elements of contacts 26 and 28 (electrical and/or physical contacts) are shown in schematic representations on the end of the temple tip 16 and in the slot 32 of the battery module 24. Such contacts 26 and 28 being in one or more form of mechanical, magnetic, inductive, conductive, or other known form of connection or attraction to achieve electrical and physical connection. In one embodiment, shown in FIG. 3, the corresponding electrical contacts 26 and physical contacts 28 preferably have mating recesses 26a/28a and extensions 26b/28b, that increase surface contact for improved electrical and physical connection. In addition, the groove 32 in each embodiment includes a notch 34 configured to receive a corresponding tab 36 on the temple tip 16 to provide additional securement and attachment.

In this embodiment shown in FIGS. 3 and 4, the battery module 24 engages and remains on the receptacle 22 from a posterior side, e.g., an end surface of the temple tips 16 extending along a portion of the temple tip 16 that is often positioned behind a user’s ear when worn – adding length to the temple arms 14. Alternatively, as shown in FIGS. 1 and 2, the battery module 24 and receptacle 22 are configured such that the same may engage and remain connected on a lateral side thereof, e.g., an inside or outside surface of the temple tip 16 extending toward or away from a center line of the frame 12. There is preferably a receptacle 22 and a corresponding battery 24 included on the temple tip 16 of each temple arm 14. In the embodiment shown, the form of the electrical contacts 26 and physical contacts 28 are schematically represented and understood to comprise one of the foregoing described forms.

FIG. 4 further illustrates a partially transparent view of the smart glasses 10 showing computing circuity 38, a power management circuit (PMC) 40, a back-up power source 42 and other elements contained within the frame 12 and/or temple arms 14. One such other element might include a camera 44, preferably disposed in the hinge 18 or front surface of the frame 12, adjacent to a lens 20. Although not shown in complete detail, it is understood that the computing circuity 38, power management circuit (PMC) 40, back-up power source 42 and other elements are internally connected by conductive wiring or similar technology, including connecting the PMC 40 to the electrical contacts 26 of the receptacles 22 on the temple tips 16.

Each modular accessory – whether battery or other – preferably has at its point of connection to the personal computing device multiple connection terminals, providing both power connections and additional general purpose data connections. FIGS. 3 and 4 show one preferred embodiment, in particular for use with smart glasses, schematically depicting three connection nodes within the modular accessory 24, adjacent to the side of the housing that connects to the smart glasses temple tip 16. The modular accessories 24 preferably include an assembly of circuitry 46, power storage cells 47, on-board memory 48, and additional hardware for unique functionality used to expand the capabilities by integrating new functionality into the modular accessories 24 themselves. The contacts 26 and 28 preferably include a minimum of two electrical connections – one for power and one for ground, as well as preferably at least one data connection that can access, among other components, the on-board memory 48.

The on-board memory 48 is preferably configured to store data relevant to the particular modular accessory 24 and its performance. For example, for a modular battery 24, the on-board memory 48 might identify a specific or unique battery module, the chemistry type (i.e., lithium-ion, nickel-metal hydride, lead-acid, etc.), the energy density specifications (i.e., how much energy can be stored), the life cycle parameters (i.e., how many complete charge-discharge cycles are possible before capacity degrades to less than 80% of original capacity), the self-discharge rate (i.e., how quickly a charge dissipates when not in use), the charge/discharge rate during usage, the operating temperature parameters, the internal resistance values, the actual charging cycle count, and authentication data for supported hardware. For other accessory modules, the data storage capabilities might store critical operational data, such as for GPS (location history, trip history, mode of travel, etc.), activity tracker (steps, duration, distance, frequency, etc.), for camera or microphone (video files, digital images, audio files, etc.), and for health monitoring (heart rate, blood-oxygen ratio, blood pressure, body temperature, sleep cycles, etc.).

The contacts 26 or 28 are preferably physically connected for power transmission, such as via induction or exposed pins, i.e., pogo or spring-loaded pins. Similar physical contacts 26 or 28 are preferably also used for data transmission as described. Alternatively, data transmission may occur wirelessly via antenna 58, e.g., near-field, Bluetooth, etc., with the wearable devices 10 or an associated external device, e.g., smart phone. For data transmission methods, data transmission may be wired via physical connection terminals, or optionally wireless data transmission capabilities to a wearable device (i.e., smart glasses); or associated smartphones or other compatible devices. For enhanced functionality options, the accessory modules or corresponding cases preferably include multiple input/output expansions, such as USB-C ports, SD card slots, headphone jacks, physical buttons, scroll wheels, touch input surfaces, haptic actuators, microphones, and/or cameras. In addition, extended device capabilities may include expanded storage or memory, extended-range antenna for Bluetooth or Wi-Fi, satellite (GNSS) positioning hardware, and/or additional wireless communication protocols.

As mentioned above, one of the primary purposes of the swappable modular accessories/batteries is the preservation of seamless and uninterrupted operation of computing devices. There can be accomplished through multiple modular batteries connected to a given computing device at any given time. Each of such multiple modular batteries can have varying voltages depending upon how much charge each battery has at a given moment and its number of charge cycles, i.e., how many times a battery has been charged and discharged.

Each swappable or modular accessory and its point of connection to the computing device preferably has multiple connection terminals, providing both power connections, as well as additional general purpose data connections. FIG. 4 shows one preferred embodiment, in particular, schematically depicting three connection nodes within the modular accessory, adjacent to the side of the housing that connects to the computing device, i.e., smart glasses frame. The modular accessories include a configuration of circuitry, battery storage cells, on-board memory, and additional hardware for unique functionality used to expand the capabilities by integrating new functionality into the modular accessories themselves. The power connections preferably include a minimum of two contacts – one for power and one for ground. The data connections are preferably one or more contacts that can access, among other components, the on-board memory capable of storing data as described more fully herein.

Just as the power connections need to be wired for power transmission, so to may the modular accessories use wired contacts via induction or exposed pins, i.e., pogo or spring-loaded pins, for data transmission. Alternatively, the data transmission may occur wirelessly with the battery case, docking station, computing device, or an associated smart phone.

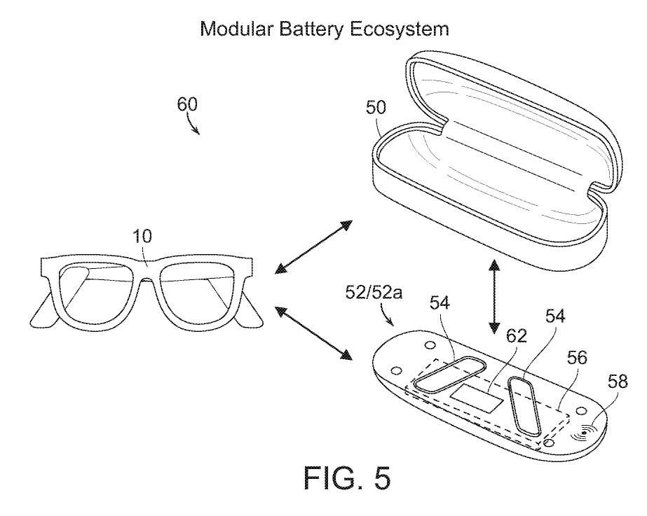

FIG. 5 illustrates an embodiment of a modular battery system (e.g., ecosystem) 60 for personal and wearable electronic devices of the type described herein that includes the device, a case, and an accessory cradle. The modular battery system 60 may wirelessly charge the modular batteries 24 as described above or charge the same through physical contact of electrical connections within an accessory cradle 52 removably stored in a case 50. Similarly, other accessory modules 24 may be charged (if they have on-board power storage) or otherwise transfer data regarding usage or maintenance when placed in such an accessory cradle 52. Similarly, other accessory modules 24 may also be removed and stored in a comparable case 50 or docking station/cradle 52 as described herein.

The particular embodiment shown is for use with smart glasses 10 and includes a glasses case 50 with an accessory cradle 52. The case 50 may be a simplified form of a glasses case, where charging or other electronic components may be independent of the case 50, preferably in the accessory cradle 52a. The accessory cradle 52a may be further described as an accessory charging cradle 52. The accessory charging cradle 52 preferably includes two or more charging slots 54, each configured for receiving a 24 as described above, and a power storage cell 56. The power storage cell 56 is designed to hold a significant charge larger than that capable of being held by the modular battery cell 47. The charge from the power storage cell 56 may be transferred to individual modular accessories/batteries 24 placed into the charging slots 54. When placed into a charging slot 54, the modular accessories/batteries 24 may be recharged either by electrical connection with contacts 26 or 28 and corresponding contacts (not shown) in the charging slot 54 or by near-field or induction connection.

The power storage cell 56 of the accessory cradle 52 can be recharged by wired connection to another power source or similarly by wireless near field or induction connection. In one embodiment, the case 50 may include electrical components – either contacts or contactless – that can recharge the power storage cell 56 when the same is positioned in the case 50.

In a preferred configuration, two modular batteries 24 may be connected to the smart glasses 10 to provide power thereto, and two or more additional modular batteries 24 may be stored in the charging cradle 52 depending on the number of charging slots 54. When one or more of the modular batteries 24 connected to the smart glasses 10 are sufficiently depleted in charge, they may be swapped with one or more of the modular batteries 24 stored in the charging slots 54 on the charging cradle 52. In this way, the modular batteries 24 may be “hot-swapped”, meaning that one modular battery 24 may be replaced while a second modular battery 24 remains connected and powering the smart glasses 10 until a replacement modular battery 24 is connected. The “hot-swapping” system is designed to keep the smart glasses consistently powered and operational.

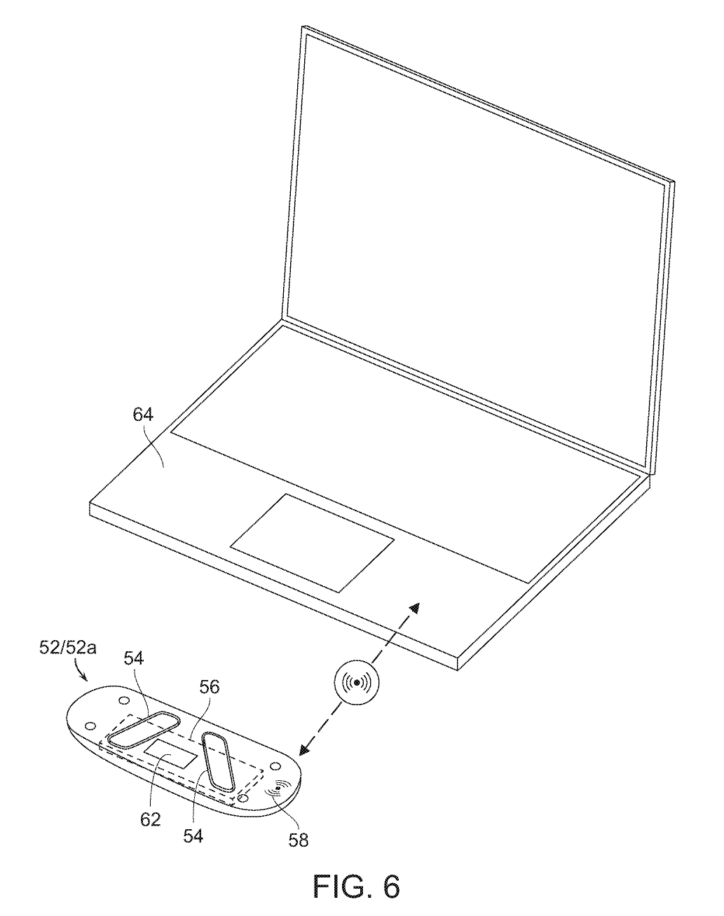

The accessory cradle 52 also includes a large capacity data storage chip 62 configured to connect to the memory 48 on a modular accessory/battery 24 and receive a transfer of digital data, e.g., audio/video files, therefrom. The cradle data storage chip 62 is configured to receive the transfer of and store digital data from the memory 48 of multiple modular accessories/batteries 24 at the same time or over time. As illustrated in FIG. 6, the accessory cradle 52 can then transfer the digital data stored in the cradle data storage chip 62 to a remote computing device 64 such as a laptop or other computer. Such transfer may be accomplished by wired connection or wirelessly via antenna 58 by LAN, Wi-Fi, and Bluetooth. In this way, the power required to transfer the digital data to a remote computing device 64 is provided by the power storage cell 56 of the accessory cradle 52, having a much larger capacity of power to handle the data transfer, while not drawing on the smaller charge contained in the modular battery cell 47. In this way, the charge contained in the modular battery cell 47 is preserved to maintain consistent operation of the personal computing device 10.

In addition to maintaining consistent power and operation of the smart glasses 10, another primary benefit of the swappable modular batteries is the preservation of battery lifetime. There can be multiple modular batteries 24 connected to a given personal computing device at any given time. Each of such multiple modular batteries 24 can have varying voltages depending upon how much charge each has at a given moment and its number of historical charge cycles, i.e., how many times a battery has been charged and discharged. Each modular battery 24 may be connected to its own small-printed circuit board (PCB) with a microcontroller and “fuel gauge” integrated circuit (IC) that tracks the cycles of that particular modular battery 24 by saving the information to EEPROM or other on-board memory storage. This configuration provides data to the power management circuit (PMC) 40 over a suitable digital connection (I2C or similar) and allows for setting recommendations to the user. For example, with smart glasses, if a user repeatedly changes only one modular battery 24, e.g., the right one, when the charge gets low, but rarely changes the other modular battery 24, the PMC 40 of the device may recommend the user to swap left and right modular batteries 24 to better balance the operation for uniform charge and cycles, i.e., wear and tear.

The PMC 40 may be set into a "battery lifespan extending" mode, in multiple ways. The PCB 40 and an IC “fuel gauge” may automatically set such mode. Alternatively, a processor 38 on the main device (e.g. smart glasses 10) may command the PMC 40 to set such mode. Such a main device processor may be part of an IC separate from the PMC – or the main device processor can itself be the PMC in a unified implementation. Further, the user may manually set such operation mode in the software settings. Such a “battery lifespan extending” mode would preferably draw power from each modular battery 24 alternately and equally to deplete them both more uniformly, switching periodically or drawing in parallel. Such mode might alternatively prevent depleting one modular battery 24 below a pre-determined threshold until all available power from the other modular battery 24 is depleted. For example, assuming both modular batteries 24 start at 100%, the system may be configured to use both modular batteries 24 down to 25% before continuing to use one modular battery 24 one down to 0% and then switching to the other modular battery 24. Such configuration prolongs the time before a single modular battery 24 is depleted below a point that would otherwise diminish its lifetime capacity or functionality.

Examples of additional functionality for use with modular accessories within this system 60, might include: (1) accessory modules 24 with various input-output options, i.e., USB-C, SD card, headphone jack, buttons, scroll wheel, touch inputs, haptic actuators, microphones, or camera; (2) accessory modules 24 with expanded device capabilities or sensors, expandable storage or memory, extended range antenna for Bluetooth or wi-fi, satellite (GNSS) positioning, or other wireless communication; or (3) accessory modules 24 with pinouts in several forms – ideally about 6-8 pins for power, data, and several additional sensor and communications pins.

The modular accessory system 60 with integrated data storage and transfer capabilities consists primarily of memory-enhanced modular accessories/batteries 24. In addition to rechargeable battery components and controls, the modular accessories incorporate internal data storage components 48. Such data storage 48 may be implemented as permanent (i.e., soldered) memory components, removable storage formats (i.e., micro-SD cards), or comparable digital data storage of a type currently known or to be discovered in the future. The memory components 48 preferably store digital media captured by the computing device 10 or an associated modular accessory 24. The modular accessories/batteries 24 maintain both power supply and data storage functions. Multiple modular batteries 24 may be swapped throughout the day as power is depleted. When a modular battery is swapped, the data contained on the integrated data storage 48 stays with the modular battery 24 when it is moved to a case 50 or docking station/cradle 52 to be recharged.

As described, an intelligent charging cradle or a corresponding docking station 52 preferably includes its own larger-capacity memory component 62, in addition to a larger reservoir of power storage via a large battery cell 56 or a wired electrical supply. Such a charging case 50 or docking station 52 connects to modular batteries 24 through the aforementioned physical connection points 26/28. When a depleted or near depleted modular battery 24 is placed in the case 50 or cradle 52, the battery 24 begins recharging. In addition, data files stored on the battery's memory 48 may be transferred to the memory 62 contained in the case 50 or the docking station 52. Such transfer of data files can be initiated automatically or may only occur upon a user’s activation of a switch or similar trigger. Transfer preferably occurs through direct physical connection, but with a larger energy reservoir 56, it is available to reliably use wireless transfer methods via antenna 58 that tend to be more power-intensive, with less concern for depleting the power reservoir 47 of the modular battery 24 or otherwise running out of power.

Pursuant to the described invention, a staged data transfer process may include: Stage 1: media capture stored on internal memory in the internal circuitry 38 of the computing device 10; Stage 2: data transfer from the computing device 10 to the memory 48 of the modular battery 24; Stage 3: data transferred from modular battery 24 to case/cradle 50/52 during recharge cycle; and Stage 4: charging case/cradle 50/52 with significantly larger power capacity completes wired/wireless transfer to user's smartphone, cloud storage services, or other connected devices 64. In addition, multiple battery slots 54 included in the docking cradle 52 may accommodate multiple modular batteries 24 simultaneously; be connect to a persistent power supply such as an electrical outlet; enable synchronization of multiple batteries 24 at once; and provide for data transfer from all docked modular batteries 24 to be consolidated in the large data chip 62 on the cradle 52 for efficient transfer.

Advantages of the configuration described include increased power efficiency, seamless operation, increased reliability, and enhanced practicality. For increased power efficiency, the described configuration shifts energy-intensive wireless data transfer operations from small modular batteries to a larger-capacity charging case or station, extends the operational life of wearable devices between battery swaps, and minimizes increased power drain from background wireless transfer processes. For seamless operation, a user can continuously operate personal computing devices by swapping depleted batteries with charged ones; transfer data automatically during a normal charging process (rather than creating latency in the operation of the computing devices); and no user intervention is required for data management. For reliability improvements, the configuration minimizes data transfer failures due to battery depletion, reduces latency issues in the computing devices associated with wireless transfer processes, and maintains data integrity across battery swaps. For enhanced practicality, the configuration eliminates the need for manual SD card handling, provides multiple pathways for data retrieval, and is compatible with existing cloud storage infrastructure.

Examples of additional functionality for use with different modular accessories 24 within this system, might include: (1) accessory modules 24 with various input-output options, i.e., USB-C, SD card, headphone jack, buttons, scroll wheel, touch inputs, haptic actuators, microphones, or camera; (2) accessory modules 24 with expanded device capabilities or sensors, expandable storage or memory, extended range antenna for Bluetooth or wi-fi, satellite (GNSS) positioning, or other wireless communication; or (3) accessory modules 24 with pinouts in several forms – ideally about6-8 pins for power, data, and several additional sensor and communications pins. Ideally, each connection terminal 22 includes at least 6-8 pins in total for power, data, and additional sensor/communications functionality as may be needed or desired by the user.

The advantages of such an inventive modular accessory system 60 include: extended device functionality without significantly increasing the size of the main personal computing unit; hot-swappable power and operation solution eliminating downtime for charging or switching accessories; customizable functionality based on user needs and activities; future-proof design allowing for new module development without replacing the entire device; comprehensive accessory health monitoring and management; and/or authentication of compatible components to ensure system integrity.

Although several embodiments have been described in detail for purposes of illustration, various modifications may be made without departing from the scope and spirit of the invention.

1. A modular accessory system for personal computing devices, comprising:
a personal computing device having internal circuitry and at least one connection point configured to provide both power transfer and data transfer;
a modular accessory removably attachable to the personal computing device at the at least one connection point, the modular accessory comprising a modular power component configured to supply power to the personal computing device and a modular memory component configured to store and transfer data; and
an accessory storage case configured to receive the modular accessory when removed from the personal computing device, the accessory storage case comprising a case power component having a greater capacity than the modular power component and a case memory component having a greater capacity than the modular memory component;
wherein the accessory storage case is configured to transfer data from the modular memory component to the case memory component or a separate mobile computing device when under power from the case power component.

2. The modular accessory system of claim 1, wherein the accessory storage case transfers data from the modular accessory to the separate mobile computing device by a wired connection or by a wireless connection comprising at least one of a local area network, Wi-Fi, and Bluetooth.

3. The modular accessory system of claim 1, wherein data is transferred from the modular accessory to the accessory storage case by a direct physical connection between the modular accessory and the accessory storage case.

4. The modular accessory system of claim 3, wherein the direct physical connection between the modular accessory and the accessory storage case comprises induction or exposed pins.

5. The modular accessory system of claim 1, wherein the data transfer from the modular accessory to the accessory storage case is initiated automatically upon placement of the modular accessory in the accessory storage case, or upon manual activation by a user.

6. The modular accessory system of claim 1, wherein the at least one connection point connects the modular accessory to the internal circuitry of the personal computing device via induction or exposed pins, the connection point providing at least one power contact, at least one ground contact, and at least one data contact.

7. The modular accessory system of claim 1, wherein the modular accessory is physically attached to the personal computing device by a magnet or a mechanical locking mechanism.

8. The modular accessory system of claim 1, wherein the personal computing device is a wearable electronic device selected from the group consisting of smart glasses, a smart watch, a GPS device, a camera, a microphone, an activity tracker, and a health monitor, and wherein the modular accessory is a rechargeable modular battery.

9. The modular accessory system of claim 8, wherein the personal computing device is smart glasses and wherein the rechargeable modular battery is attached to a temple arm of the smart glasses.

10. A modular battery system for personal computing devices, comprising:
a personal computing device having internal circuitry and at least one connection point configured to provide both power transfer and data transfer;
a rechargeable modular battery removably attachable to the personal computing device at the at least one connection point, each modular battery comprising a modular battery cell configured to supply power to the personal computing device and a modular data storage configured to store digital data from the personal computing device; and
an accessory storage case configured to receive the modular battery, the accessory storage case comprising a case power component having a greater capacity than the modular battery cell and a case data storage having a greater capacity than the modular data storage;
wherein the accessory storage case is configured to transfer data from the modular data storage to the case data storage and a mobile computing device, when under power from the case power component rather than from the modular battery cell.

11. The modular battery system of claim 10, wherein the accessory storage case is configured to transfer data to the mobile computing device by a wired connection or by a wireless connection comprising at least one of a local area network, Wi-Fi, and Bluetooth.

12. The modular battery system of claim 10, wherein data is transferred from the modular battery to the accessory storage case by a direct physical connection between the modular battery and the accessory storage case comprising induction or exposed pins.

13. The modular battery system of claim 10, wherein the accessory storage case is configured to simultaneously receive a plurality of modular batteries and to consolidate data from the respective modular data storage elements of the plurality of modular batteries for transfer to the separate mobile computing device.

14. The modular battery system of claim 10, wherein the modular data storage of the modular battery is partitioned and encrypted to permit use of the modular battery across multiple personal computing devices without unintentional sharing of data, and to secure stored data if the modular battery is lost.

15. The modular battery system of claim 10, wherein the at least one connection point connects the modular battery to the internal circuitry of the personal computing device via induction or exposed pins, the connection point providing at least one power contact, at least one ground contact, and at least one data contact.

16. A modular battery system for smart glasses, comprising:
a smart glasses frame having internal circuitry and at least one connection point on at least one temple arm configured to provide both power transfer and data transfer;
at least one modular battery removably attachable to the at least one temple arm at the at least one connection point, each modular battery comprising a modular battery cell configured to supply power to the smart glasses frame and a modular data storage chip configured to store digital data from the smart glasses frame; and
an accessory storage case configured to receive the at least one modular battery, the accessory storage case comprising a case power storage having a greater capacity than the modular battery cell and a case data storage having a greater capacity than the modular data storage chip;
wherein the accessory storage case is configured to transfer data from the modular data storage chip to at least one of the case data storage and a separate mobile computing device when under power from the case power storage rather than from the modular battery cell.

17. The modular battery system of claim 16, wherein the accessory storage case transfers data to the separate mobile computing device by a wired connection or by a wireless connection comprising at least one of a local area network, Wi-Fi, and Bluetooth.

18. The modular battery system of claim 16, wherein data is transferred between the smart glasses frame and the at least one modular battery through a staged process comprising:
a first stage in which digital data is stored in internal memory of the smart glasses frame;
a second stage in which the digital data is transferred from the smart glasses frame to the modular data storage chip through the at least one connection point;
a third stage in which, upon placement of the at least one modular battery in the accessory storage case, the digital data is transferred from the modular data storage chip to the case data storage; and
a fourth stage in which the accessory storage case transfers the digital data to the separate mobile computing device or to cloud storage using power from the case power storage.

19. The modular battery system of claim 16, wherein the modular data storage chip is partitioned and encrypted to permit the at least one modular battery to be used across multiple smart glasses frames without unintentional sharing of data from other users, and to secure stored digital data if the at least one modular battery is lost.

20. The modular battery system of claim 16, wherein a first modular battery is attached to a first connection point of a first temple arm of the smart glasses frame and a second modular battery is attached to a second connection point of a second temple arm of the smart glasses frame, and wherein the first and second connection points connect the first and second modular batteries to the internal circuitry of the smart glasses frame via induction or exposed pins comprising at least one power contact, at least one ground contact, and at least one data contact in each connection point.
